(19) United States
(12) Patent Application Publication
(10) Pub. No.: US 2024/0149291 A1
(43) Pub. Date: May 9, 2024

(54) Heating Device for the Hot Melting Chamber of a Hot Melt Glue Gun

(71) Applicant: Yeu Chyuan Industrial Co., Ltd., Shuishang Township (TW)

(72) Inventor: Yung-Kuan Huang, Shuishang Township (TW)

(21) Appl. No.: 17/980,690

(22) Filed: Nov. 4, 2022

(51) Int. Cl. B05C 5/00

(52) U.S. Cl. CPC B05C 5/001

(57) ABSTRACT

The present invention relates to a heating device for the hot melting chamber of a hot melt glue gun, being a heating device fixed outside the hot melting chamber for heating. The heating device comprises two opposite holding parts configured on the outside of the hot melting chamber. Each holding part holds a resistor block. The resistor block on each side is tightly attached with an electrode plate. The electrode plates on the two sides are bonded together, so that the electrode plate can act as the common positive pole of the power supply to the resistor block, and meanwhile, the hot melting chamber can act as the common negative pole of the power supply to the resistor block. In this way, the configuration of an electrode plate under the resistor block can be omitted to reduce the size of the heating device, and less connecting wires are required between each resistor block and the positive and negative poles of the power supply, thus simplifying the welding and assembling operations.

### BACKGROUND OF INVENTION

### 1. Field of the Invention

The present invention relates generally to a heating device for the hot melting chamber of a hot melt glue gun, and more particularly to an innovative configuration of the positive and negative poles of the power supply to the resistor blocks for heating the hot melting chamber, wherein, the electrode plates tightly attached to the outside of each resistor block are bonded together and connected to the positive pole of the power supply, and meanwhile, the hot melting chamber can act as the common negative pole of the power supply to the resistor blocks, so as to simplify the configuration of wires connected to the electrode plates as well as the welding operations.

### 2. Description of Related Art

The hot melt glue gun is a tool to heat and melt the solid hot melt glue bar that passes through the hot melting chamber into gel-like liquid. The previous heating method to heat the hot melting chamber is that, a round holding chamber is configured under the hot melting chamber, the heater is held inside the chamber, and the heater heats up the hot melting chamber to melt the hot melt glue bar.

However, the heater using the above heating method is not stable, and it only provides heating on one side of the hot melting chamber, resulting in a high heating temperature of the hot melt glue bar on the side close to the heater, and a low heating temperature on the back side. Therefore, the hot melt glue bar is not heated evenly. Later, some manufacturers have improved the heater by configuring a resistor block between the two electrode plates of the positive and negative poles, thus providing a heater with more stable heating. However, the heating of the hot melting chamber is still on one side. The hot melt glue bar is not heated evenly.

The applicant's earlier patent (Taiwan TWM404737) already approved and publicized features a structure with three holding parts configured on the periphery of the hot melting chamber. Each holding part holds a heater to heat up the hot melting chamber on three sides. In this way, the hot melt glue bar passing through the hot melting chamber can be heated evenly and be melt quickly. However, the heaters configured on the periphery make the overall size of the hot melt glue gun too big.

Moreover, each heater on the periphery of the hot melting chamber must be welded with two wires for connection to the positive and negative poles of the power supply. Three heaters require six wires to be weld. This not only increases the cost of material, but also complicates the assembling operations.

### SUMMARY OF THE INVENTION

As mentioned above, the addition of heaters around the hot melting chamber of the hot melt glue gun greatly increases the overall size, and the operations to weld and connect the wires to the heaters become complicated. Therefore, the object of the present invention is to provide a heating device for the hot melting chamber of a hot melt glue gun, in which, the electrode plates of the resistor blocks tightly attached to the opposite sides of the hot melting chamber for heating and connected to the positive pole of the power supply are bonded together, so that the electrode plate can act as the common positive pole of the power supply to the resistor blocks, and meanwhile, the hot melting chamber can act as the common negative pole for the power supply to the resistor blocks. In this way, the number of wires for connection to the positive and negative poles of the power supply can be reduced, and the welding and assembling operations can be simplified.

To accomplish the above object, the present invention adopts the following technical solution:

A heating device for the hot melting chamber of a hot melt glue gun, being a heating device fixed outside the hot melting chamber for heating, characterized in that: two opposite holding parts are configured outside the hot melting chamber, each holding part holds a resistor block, the outside of each resistor block is tightly attached with an electrode plate that is connected to the positive pole of the power supply, and the electrode plates on the two sides are bonded together.

The heating device for the hot melting chamber of the hot melt glue gun, wherein: the hot melting chamber is the common negative pole of the power supply to the resistor blocks.

In this way, in the invention mentioned above, the electrode plates attached to the outside of the resistor blocks on the two sides of the hot melting chamber are jointly connected to the positive pole of the power supply, and meanwhile, the hot melting chamber can act as the common negative pole of the power supply to the resistor blocks on the two sides, thus reducing the number of wires for connection to the positive and negative poles of the power supply and simplifying the wire welding operations.

### BRIEF DESCRIPTION OF THE DRAWINGS

FIG. 1 is a perspective view of the melting chamber heating device according to the present invention.

FIG. 2 is an exploded perspective view of the melting chamber heating device according to the present invention.

FIG. 3 is a side view of the melting chamber heating device according to the present invention.

FIG. 4 is A-A sectional view of FIG. 3.

FIG. 5 is a perspective view of Embodiment 2 of the melting chamber heating device according to the present invention.

FIG. 6 is an exploded perspective view of Embodiment 2 of the melting chamber heating device according to the present invention.

FIG. 7 is a side view of Embodiment 2 of the melting chamber heating device Embodiment 2 according to the present invention.

FIG. 8 is B-B sectional view of FIG. 7.

Description of notations in the figures: 1—hot melting chamber; 11—holding part; 2—resistor block; 3, 4—electrode plate.

### DETAILED DESCRIPTION OF THE INVENTION

As disclosed in the figures, the present invention provides a heating device for the hot melting chamber of a hot melt glue gun, being a heating device fixed outside the hot melting chamber, characterized in that: the heating device comprises: two opposite holding parts are configured outside the hot melting chamber, each holding part holds a resistor block, the outside of each resistor block is tightly attached with an electrode plate that is connected to the positive pole of the power supply, and the electrode plates on the two sides are bonded together. The electrode plate acts as the common positive pole of the power supply to the resistor blocks, and meanwhile, the hot melting chamber can act as the common negative pole of the power supply to the resistor block, thus omitting the configuration of electrode plates under each of the resistor blocks. In this way, the size of the heating device can be reduced. Meanwhile, the number of wires connected between each resistor block and the positive and negative poles of the power supply can be reduced to simplify the welding and assembling operations.

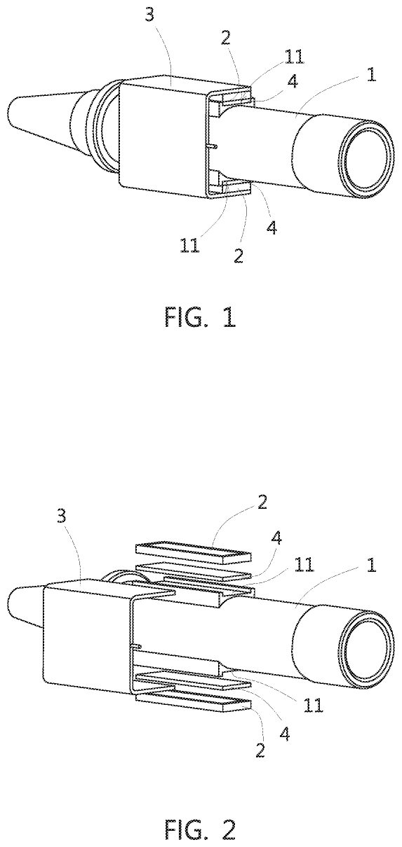

Referring to FIG. 1 and FIG. 2, in the present invention, the hot melting chamber 1 of the hot melt glue gun is configured with holding parts 11 on two opposite positions on the outside surface, and each holding part 11 holds a heating device. The heating device comprises: each holding part 11 is configured with a resistor block 2, the inner side of each resistor block 2 is tightly attached with an electrode plate 4 fixed on the holding part 11, the outer side of each resistor block 2 is tightly attached to a joint electrode plate 3. In the end, a heat-resistant insulating tape is used to bind the heating devices and fix them on the hot melting chamber 1.

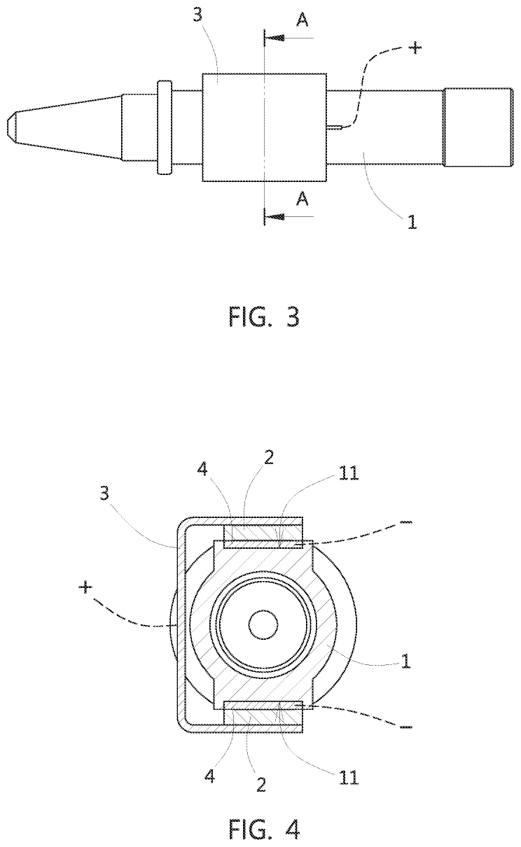

Therefore, as shown in FIG. 3 and FIG. 4, the electrode plate 3 is connected to the wire of the positive pole (+) of the power supply, and the wire of the negative pole (−) of the power supply is respectively connected to the electrode plates 4 on each side. The joint electrode plate 3 acts as the positive pole of the power supply (+), making the electrode plate 3 the common positive pole of the power supply to the resistor blocks 2. Therefore, only one wire needs to be welded and connected.

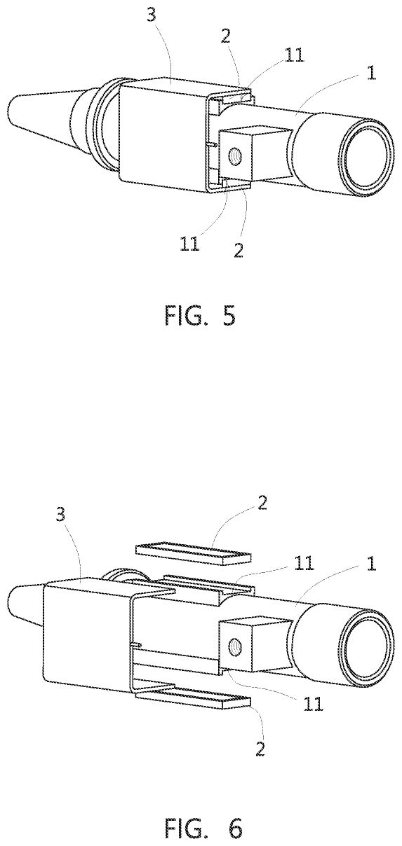

Alternatively, as shown in FIG. 5 and FIG. 6, two holding parts 11 are configured similarly on two opposite positions outside the hot melting chamber 1, and each holding part 11 holds a heating device. The heating device comprises: each holding part 11 is directly fixed with a resistor block 2, and the outside of each resistor block 2 is tightly attached to the joint electrode plate 3. In the end, a heat-resistant insulating tape is used to bind the heating devices and fix them on the hot melting chamber 1.

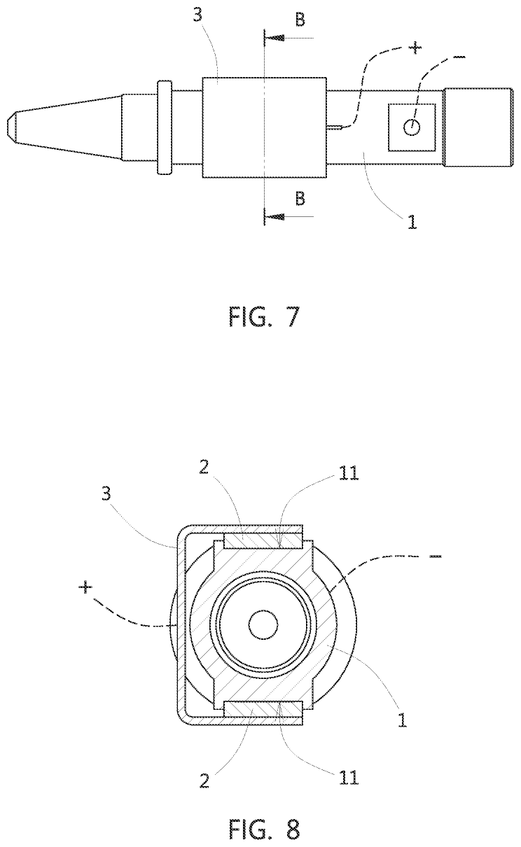

Referring to FIG. 7 and FIG. 8, the electrode plate 3 is connected to the wire of the positive pole (+) of the power supply, and only one wire needs to be welded and connected. Furthermore, the hot melting chamber 1 is used as the common pole of the power supply to the resistor blocks 2 on the two sides, i.e., the negative pole (−) of the power supply is connected to the hot melting chamber 1, using the hot melting chamber 1 as the common negative pole of the power supply to the resistor blocks 2 on the two sides. Thus, only one wire is needed for connection to the negative pole (−) of the power supply.

Therefore, either by using the joint electrode plate 3 between the resistor blocks 2 on the two sides as the common positive pole (+) of the power supply to the resistor blocks, or by additionally using the hot melting chamber 1 as the common negative pole (−) of the power supply to the resistor blocks 2 on the two sides, the number of wires for connection to the power supply can be reduced, and the consequently, the wire welding and layout operations can be simplified.

1. A heating device for the hot melting chamber of a hot melt glue gun, being a heating device fixed outside the hot melting chamber for heating, characterized in that: on the two sides of the hot melting chamber, two opposite holding parts are configured, each holding part holds a resistor block, the outside of each resistor block is tightly attached with an electrode plate that is connected to the positive pole of the power supply, and the electrode plates on the two sides are bonded together.

2. The heating device for the hot melting chamber of a hot melt glue gun defined in claim 1, characterized in that: the hot melting chamber is the common negative pole of the power supply to the resistor blocks.
